(19) United States
(12) Patent Application Publication
(10) Pub. No.: US 2007/0262164 A1
(43) Pub. Date: Nov. 15, 2007

(54) Drinking Straw

(76) Inventor: Daniel Gelfand, Wellington, FL (US)

Correspondence Address: ROGERS IP GROUP, PO BOX 152662, TAMPA, FL, 33684, US

(21) Appl. No.: 11/381,077

(22) Filed: May 1, 2006

(51) Int. Cl. E03B 9/20; A47G 21/18; A61J 15/00

(52) U.S. Cl. 239/33; 239/16

(57) ABSTRACT

A drinking straw which includes a tube having a distal opening and a proximate opening as well as a one-way valve attached to the distal opening of the straw. The valve is preferably made from a flexible material so that it can easily and conveniently be removed from the distal opening of the straw. In one preferred embodiment, the valve at the proximal opening comprises a cylindrical elastomeric body with a first end and second end. The first end is connected by a cylindrical midsection to the second end which has an oval shaped outer wall terminating in an open mouth. The valve further includes parabolically tapered walls located near the first end converging towards an elongated slit defined by lips. A collar is also positioned near the second end which projects radially outwardly from the outer wall of the midsection. In another preferred embodiment, the straw is part of a kit which includes devices for measuring and loading substances into the drinking straw. Also disclosed are methods for using the drinking straw to administer medications. In one preferred embodiment, a user loads a substance through the proximate opening of the tube of the straw, places the opposite opening of the tube into a beverage of choice and sipes on the proximal opening of the tube so the beverage is drawn up through the elongated slit of the valve into the tube, mixes with the loaded substance and is then drawn into the mouth of the user.

### DESCRIPTION

1. Technical Field

The present invention relates to drinking tubes and straws and, more particularly, is directed to a portable drinking straw adapted for the convenient administration of substances such as medications, and processes of dispensing substances using the same.

2. Description of Prior Art

Various types of drinking straws have been developed for the consumable beverage industry. U.S. Pat. No. 6,050,444 to Sugg discloses one such straw which extends from a valve assembly having a flexible diaphragm. The straw and valve assembly are all part of a beverage container which collapses as beverage is withdrawn from the container. Although the straw and valve assembly is particularly suitable for use in its specially designed container, it is not particularly well adapted to be conveniently used apart from its container for the administration of liquids. Such a portable straw which permits forward movement of liquid into the straw but prevents backward flow at one end of the straw is of particular interest to people who wish to conveniently dispense medications. In such a device, medication can be loaded through the top of the straw, and the distal end can then be inserted into a liquid of choice. Upon pressure exerted from a user's mouth at the top of the straw, liquid from the beverage can then be drawn up into the straw, mixed with the preloaded medication and then drawn up into the user's mouth. Children who are particularly sensitive to bad tastes from over the counter and prescribed medications would particularly benefit from such a device.

U.S. Pat. No. 5,718,681 to Manning discloses a medication delivery straw for delivering powdered medications through a straw. The straw includes barrier apertures which are small enough in diameter to retain substantially all of a preloaded dry medicine into the straw. Liquid can be drawn up through the barrier apertures after suction applied at the top of the straw, which can thereafter mix with the pre-loaded medication and then be sucked up into the user's mouth. Barriers such as the one described by Manning are semi-permeable by their nature which adds a time constraint before the medicine pre-loaded into the barrier can diffuse out of the apertures.

Another disadvantage with the medication delivery straw disclosed by Manning is that it does not prevent retrograde movement of liquid from the straw back out of the straw, unless the liquid is viscous. Thus although the device can be used for dry powders and the like, it can not be used for non-viscous liquid medications. Moreover, liquids which are so viscous as not to seep through such apertures tend to clog the pores in the barrier, requiring a larger then normal vacuum to dislodge the clogging which may result in choking by the user of the straw. The lack of anti-retrograde movement is even problematic for the intended use of the straw with dry or viscous medications. Even if a dry powder or viscous medication is properly dissolved from fluid entering through the barrier apertures, the now dissolved medication is no longer prevented from flowing back out through the straw because it is no longer in a dry or viscous state. This inability to prevent retrograde movement is particularly problematic for users who are not able to suck up all of the dissolved medication in a single sip. Such users will find that should suction being applied to the top of the straw be discontinued, any dissolved medication is now free to flow back out through the straw through the apertures. Thus users who are unable to maintain a proper seal between their mouth and the top of the straw or who are simply unable to suck up all of the dissolved medication in one sip, due to shortness of breath and the like, will find the straw disclosed by Manning problematic.

Manning also discloses an alternative embodiment where a medicine sack is used to contain the preloaded dry medication much like a teabag holds tea. The medicine sack is secured inside the fluid path of the straw and as fluid passes through the walls of the medicine sack, the drug medication is dissolved. As with the barrier apertures disclosed by Manning, a medicine sack is also semi-permeable by nature which adds a time constraint before the medication contained in the sack can diffuse out of the sack. The teabag, itself, also adds considerable resistance to liquid being drawn up through the straw. Yet another disadvantage with this disclosed embodiment is that the porous sacks must be secured to the inside of the straw during manufacture so that it can not be easily removed by the user either to preload medication or so that it can be cleaned and reused.

Thus there still exists a need for a drinking straw which can more easily be used to dispense dry and viscous substances. Such a straw should also provide for anti-retrograde movement back through the straw so that liquid substances can easily be preloaded and dispensed from the straw. The straw should be simply to use, assemble and be reusable.

### SUMMARY OF THE INVENTION

The present invention is directed to a drinking straw which includes a tube having a distal opening and a proximate opening as well as a one-way valve attached to the distal opening of the straw. In a preferred embodiment of the invention, the valve at the proximal opening comprises a cylindrical elastomeric body with a first end and second end. The first end is connected by a cylindrical midsection to the second end which has an oval shaped outer wall terminating in an open mouth. The valve further includes parabolically tapered walls located near the first end converging towards an elongated slit defined by lips. A collar is also positioned near the second end which projects radially outwardly from the outer wall of the midsection.

In one aspect of the invention, the drinking straw is part of a kit which includes a syringe to load substances into the straw. In another aspect of the invention, the valve is made of a flexible material such as rubber and is easily removable from the distal opening of the straw. In another aspect of the invention, the tube of the straw includes one or more weakened points which can be snapped apart so as to shorten the drinking straw.

The present invention is also directed to processes of administering medications by loading a substance through the proximate opening of the tube of the drinking straw, placing the proximate end of the tube into the mouth of its user, placing the distal opening of the tube into a beverage of choice, and then sipping on the proximal opening of the tube so that beverage is drawn up through the valve of the tube, mixes with the loaded substance and is finally drawn into the mouth of the user of the straw.

### BRIEF DESCRIPTION OF THE DRAWINGS

FIG. 1 is a front view of a drinking straw according to a first embodiment of the present invention.

FIG. 2 is a front view of a valve according to a first embodiment of the present invention, showing the valve in an open position.

FIG. 2a is a front view of a valve according to an embodiment of the present invention, showing the valve in a closed position.

FIG. 3 is a front view of a tube of the drinking straw according to a preferred embodiment of the current invention.

FIG. 4 is a perspective view showing the straw of the current invention in use.

### DETAILED WRITTEN DESCRIPTION

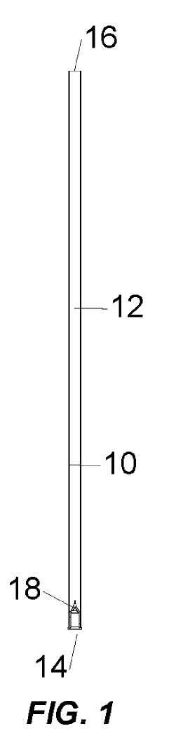

Referring now to the drawings, in FIG. 1, there is shown a drinking straw 10 illustrating a preferred embodiment of the present invention. Drinking straw 10 includes a tube 12 having a distal opening 14 and proximate opening 16. A valve 18 is inserted through distal opening 14.

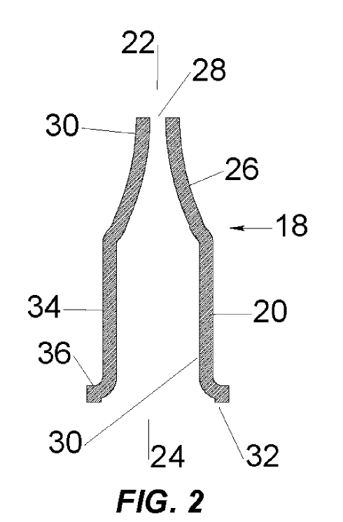

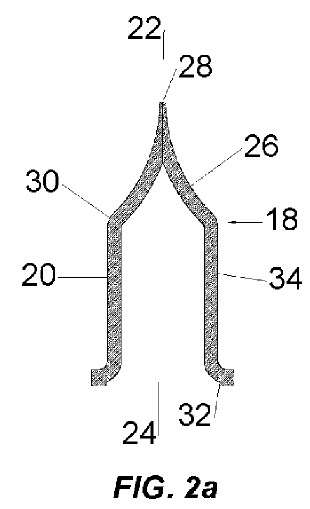

FIGS. 2-2a illustrate valve 18 of a preferred embodiment of the present invention. Valve 18 includes a cylindrical elastomeric body 20 with first end 22 and second end 24. Parabolically tapered walls 26 are located near the first end converging towards an elongated slit 28 defined by lips 30. The second end of the elastomeric body has an oval shaped outer wall 30 terminating in an open mouth 32. A cylindrical midsection 34 connects the first and second ends. A collar 36 is positioned near the second end and projects radially outwardly from outer walls 30 of the midsection.

Valve 18 can be made from rubber or any other suitable material and can come in any color. In one preferred embodiment valve 18 is made out of a medical or food grade rubber and is latex free. Valve 18 can also come in various dimensions so long as midsection 34 has a diameter small enough to allow it to be pushed through distal opening 14 of tube 12.

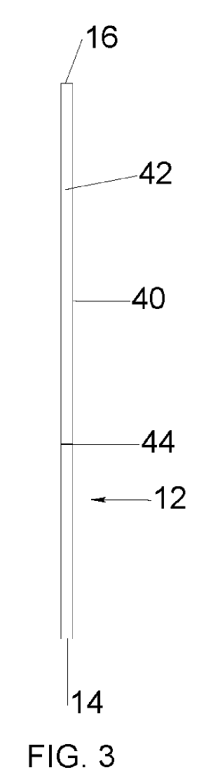

Referring to FIG. 3, tube 12 includes a tubular member 40 including a throughbore 42. In one preferred embodiment, tube 12 has one or more weakened points 44 at predetermined distances along tubular member 40 which can be snapped apart so as to shorten tube 12. This embodiment of the current invention is particularly useful for users who would like to adjust the length of tube 12 to more easily dispense substances from tube 12. As an example, a user of straw 10 may wish to shorten tube 12 by snapping off a portion of tube 12 along weakened point 44 so that an entire dose of medication inside tube 12 can be taken in one or two sips.

Tube 12 may be made of any suitable material and can come in any number of shapes and sizes as well as any color. In a preferred embodiment, tube 12 is shaped like an ordinary drinking straw. In one preferred embodiment tube 12 is made out of plastic and is neon colored in order to be attractive to kids. Tube 12 can contain various volumes of liquids. In one preferred embodiment tube 12 can contain 8 milliliters. However, different volumes are also possible and smaller volumes can also be obtained by shortening tube 12 by snapping off parts of tube 12 along weakened points 44.

In one preferred embodiment of the present invention, straw 10 is part of a kit which includes devices used to measure and load liquids into tube 12. In one such preferred embodiment, straw 10 includes a syringe used to measure and dispense medications into tube 12. The present invention further includes methods of using said kits to dispense said medications. In one preferred embodiment, medication, either solid or liquid, is first dissolved in a container such as a glass, then the syringe is used to suck up the dissolved medication and load the medication into tube 12 through proximate opening 16.

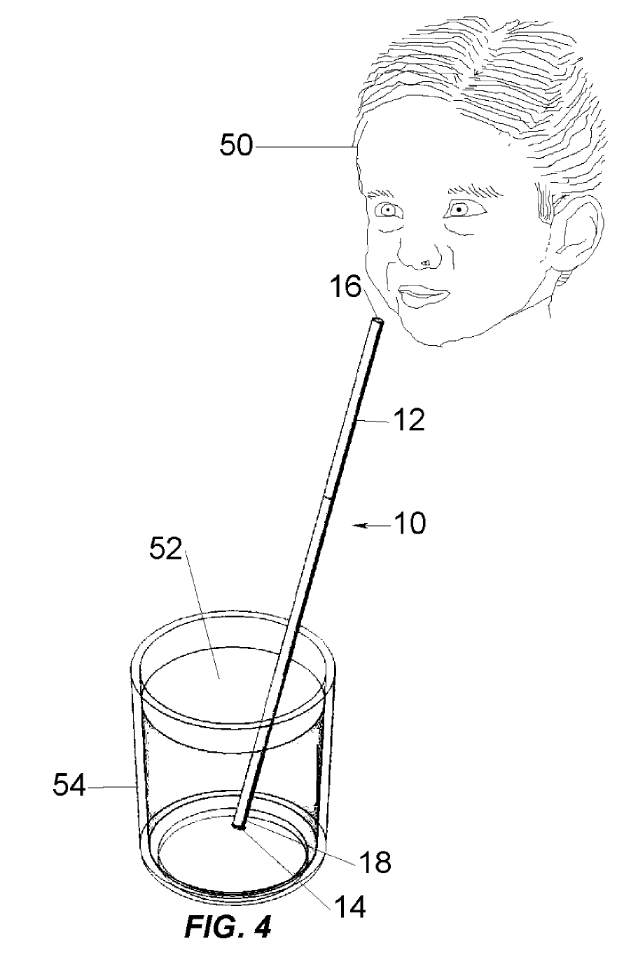

Referring to FIG. 4, shown is a preferred embodiment of the present invention in use. The proximal opening 16 of straw 10 is inserted into the mouth of its user 50 while distal opening 14 is inserted into a liquid beverage 52 to be consumed. It should be understood that words “proximal” and “distal” are used here merely to denote which end of tube 12 is inserted into beverage 52 and which end of tube 12 is inserted into the mouth of user 50. A unique advantage of the preferred embodiment of the current invention is that valve 18 can conveniently and easily be inserted into either opening of tube 12, in which case the terms “distal” and “proximal” would be reversed.

As suction is applied by user 50, beverage liquid 52 from beverage container 54 is drawn up through valve 18 of straw 10 and into throughbore 42 of tubular member 40 of tube 12 where it can mix with any other substance loaded into throughbore 42 of tubular member 40 through proximal opening 16 of straw 10. Such substances may be in liquid or powder form, and preferably include over the counter or prescribed liquid medications. Parents of children may also find it useful to pre-prime or pre-dilute medications loaded into throughbore 42 of tubular member 40 by sucking at proximal opening 16 of straw 10 so as to pre-prime or pre-dilute medications prior to giving straw 10 to a child.

An advantage the foregoing preferred embodiments of the current invention is that straw 10 can be quickly and easily cleaned by pulling out valve 18 from distal opening 14 of tube 12, washing tube 12 and valve 18 and then inserting valve 18 back into distal opening 14 of tube 12. Thus straw 10 is easily reusable.

Since certain changes may be made in the foregoing disclosure without departing from the scope of the invention herein involved, it is intended that all matter contained in the above description and depicted in the accompanying drawings be construed in an illustrative and not in a limiting sense.

What is claimed is:

1. A drinking straw, comprising: a tube comprising a tubular member having a distal opening and a proximate opening which allows for loading of a substance through said proximate opening; and a valve attached to said distal opening which allows for forward flow of liquid through said valve toward said proximate opening of said tube but which prevents backward flow of liquid through said valve, wherein liquid can be drawn up through said valve through said distal opening of said tube towards said proximal opening.

2. A drinking straw of claim 1 wherein said valve is removable from said proximate opening of said tube.

3. A drinking straw as defined in claim 1, wherein said tube has one or more weakened points at predetermined distances along said tubular member, wherein said weakened points can be snapped apart so as to shorten said tube.

4. A drinking straw as defined in claim 1, wherein said straw is part of a kit which includes a device for measuring and loading substances into said straw.

5. A drinking straw as defined in claim 4, wherein said device comprises a syringe.

6. A drinking straw, comprising: a tube comprising a tubular member having a distal opening and a proximate opening which allows for loading of a substance through said proximate opening; and a valve comprising a cylindrical elastomeric body with a first end connected by a cylindrical midsection to a second end having an oval shaped outer wall terminating in an open mouth and further including parabolically tapered walls located near the first end converging towards an elongated slit defined by lips, and further comprising a collar positioned near the second end which projects radially outwardly from said outer wall of said midsection, said valve permitting forward flow but preventing backward flow through said lips.

7. A drinking straw as defined in claim 6, wherein said tube has one or more weakened points at predetermined distances along said tubular member, wherein said weakened points can be snapped apart so as to shorten said tube.

8. A drinking straw as defined in claim 6, wherein said valve is removable from said proximate opening of said tube.

9. A drinking straw as defined in claim 6, wherein said straw is part of a kit which includes a device for measuring and loading substances into said straw.

10. A drinking straw as defined in claim 9, wherein said device comprises a syringe.

11. A drinking straw, comprising: a tube comprising a tubular member having one or more weakened points at predetermined distances along said tubular member, wherein said weakened points can be snapped apart so as to shorten said tube, and further including a distal opening and a proximate opening which allows for loading of a substance through said proximate opening; and a removable valve comprising a cylindrical elastomeric body with a first end connected by a cylindrical midsection to a second end having an oval shaped outer wall terminating in an open mouth and further including parabolically tapered walls located near the first end converging towards an elongated slit defined by lips and further comprising a collar positioned near the second end which projects radially outwardly from said outer wall of said midsection, said valve permitting forward flow but preventing backward flow through said lips.

12. A drinking straw as defined in claim 11, wherein said straw is part of a kit which includes a device for measuring and loading substances into said straw.

13. A drinking straw as defined in claim 11, wherein said device comprises a syringe.

14. A process of administering medications, comprising: providing a tube comprising a tubular member having a distal opening and a proximate opening which allows for loading of a substance through said proximate opening; providing a valve comprising a cylindrical elastomeric body with a first end connected by a cylindrical midsection to a second end having an oval shaped outer wall terminating in an open mouth and further including parabolically tapered walls located near the first end converging towards an elongated slit defined by lips and further comprising a collar positioned near the second end which projects radially outwardly from said outer wall of said midsection, said valve permitting forward flow but preventing backward flow through said lips; loading a substance through said proximate opening into said tube; placing said proximate opening of said tube into the mouth of a user; placing said distal opening of said tube into a beverage of choice; and sipping on said proximal opening of said tube, wherein said beverage is drawn up through said elongated slit of said valve into said tube, mixes with said substance and is drawn into the mouth of said user.

15. A process for administering medications as defined in claim 14, wherein said tube has one or more weakened points at predetermined distances along said tubular member, wherein said weakened points can be snapped apart so as to shorten said tube.

16. A process for administering medications as defined in claim 14, wherein said valve is removable from said proximate opening of said tube.

17. A process for administering medications as defined in claim 14, wherein said straw is part of a kit which includes a device for measuring and loading substances into said straw.

18. A process for administering medications as defined in claim 17, wherein said device comprises a syringe.
